(19) United States
(12) Patent Application Publication
(10) Pub. No.: US 2017/0359963 A1
(43) Pub. Date: Dec. 21, 2017

(54) Method of attaching a removable saw blade to a reciprocating hedge trimmer

(71) Applicant: Gregory Wiley Orr, Lexington, MA (US)

(72) Inventor: Gregory Wiley Orr, Lexington, MA (US)

(21) Appl. No.: 15/186,513

(22) Filed: Jun. 19, 2016

(51) Int. Cl. A01G 3/053; B25G 1/04

(52) U.S. Cl. CPC A01G 3/053; B25G 1/04

(57) ABSTRACT

A method for attaching a removable saw blade to a reciprocating type hedge trimmer to extend the utility for cutting larger diameter stalks without requiring a second appliance. The removable nature of the blade allows replacement should the blade become dull or damaged, and also allows use of the trimmer without the blade installed with minimal impact to the base functionality of the trimmer. Such trimmer can be hand held or machine mounted and powered by a variety of power sources.

### SUMMARY OF THE INVENTION

This invention extends the utility of a motorized hedge trimmer, whether powered by electric motor or internal combustion engine, by attaching a removable saw blade to the end of the reciprocating blade that will cut branches that are too large for the shearing blades of the trimmer to cut. The removable blade is replaceable should it become dull or otherwise compromised and the trimmer can be operated conventionally when there is no need for the ability to cut larger diameter branches, and removable so as not to limit the effectiveness of the base functions when not required.

### BACKGROUND

While there are patents on record, some of which are listed, of hedge trimmers designed for the cutting of heavier branches, the invention described here is unique in that the cutting blade is removable and replaceable by the operator without special tools or disturbing the basic components of the hedge trimmer, or can be removed entirely when not needed. This removable feature allows the functionality of the base trimmer to be minimally impacted when the reciprocating saw blade is not required and does not limit the maneuverability of the trimmer in relation to fixed obstacles commonly encountered during routine operation.

| Pat. No. | Filing Date | Publication Date | Author | Description |
|---|---|---|---|---|
| 3,309,769 | Mar. 22, 1965 | Mar. 21, 1967 | Maxxon, Ralph C | Hedge Trimmer having a |
| | | | | reciprocating saw blade |
| 5,581,891 | Aug. 12, 1994 | Dec. 10, 1996 | Wheeler et al | Hedge trimmer with combination |
| | | | | shearing and sawing blade |
| | | | | assembly |
| 4,280,276 | Jan. 18, 1980 | Jul. 28, 1981 | Comer, Robert C. | Reciprocating cutter |
| | | | Kruzel, Thomas F. | |

### DETAILED DESCRIPTION OF THE INVENTION

As shown in FIG. 1, the traditional hedge trimmer consists of a motor or engine (1), in a housing (2) that houses the transmission system and is the primary user interface, a stationary blade (3) that is attached to the handle, a reciprocating blade (4), a retention or guide bar (5), secured to the stationary blade and retaining the reciprocating blade via fasteners (6) and potentially spacers (7). This invention, shown in detail in FIG. 2, incorporates an essential bracket (8) integrally formed or attached mechanically via fastener, weld, braze or other suitable means to the reciprocating blade (4) that will receive the removable saw blade (9) and an essential means to clamp the blade securely via a set screw (10) or other clamping device to provide adequate compressive force to hold the removable saw blade (9) in place in operation. The stationary blade (3) is extended slightly to form a stop (11) for the branch to be cut against. The saw blade (9) may be single or double sided and designed such that the cut is made on the retracting, or pull stroke such that the branch being cut is pulled against the stop. The bracket (8) must be positioned on the reciprocating blade (4) such that there is no interference with the guide bar (5) over the full range of motion of the reciprocating blade (4). The removable saw blade (9) must be of adequate length to accommodate the maximum branch diameter plus 2× the throw of the reciprocating blade (4). The Stationary blade stop (11) must be placed such that the saw blade teeth at the maximum throw of the reciprocating blade (4) correspond with the stop (11) feature of the stationary blade. The saw blade (9) should be designed such that the axial force generated by the motor or engine and transmission system is adequate drive the saw blade (9) through the maximum sized branch reasonably encountered in the trimming of hedges or other shrubbery commonly trimmed in the conduct of landscape maintenance.

### DESCRIPTION OF DRAWINGS

FIG. 1 is an isometric view of the overall hedge trimmer with the removable saw blade installed. Basic components of the device are identified in this view.

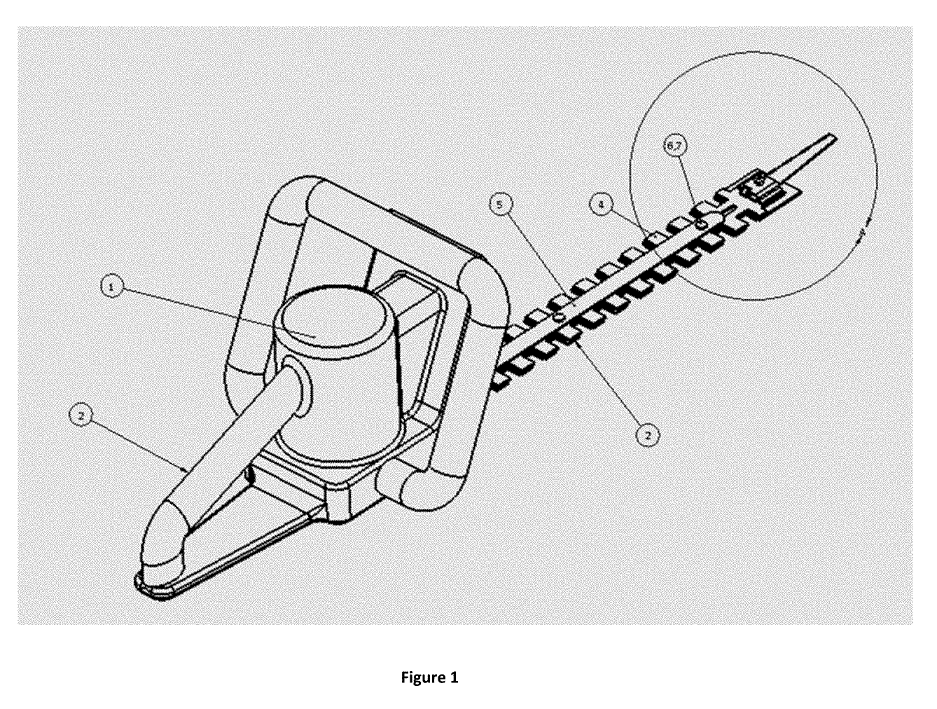

FIG. 2 is a detail view of the mounting provisions for the removable saw blade. Individual components related to the function of the invention are identified in this figure.

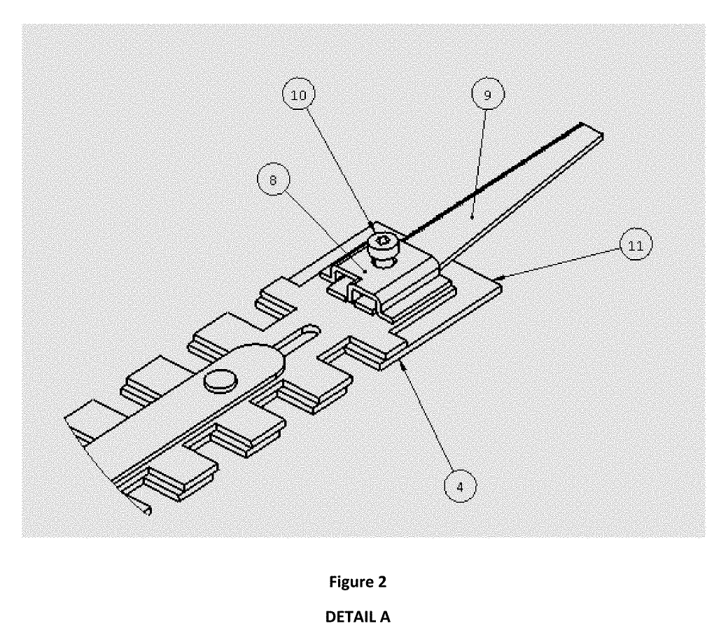

FIG. 3 is a partial section view through the removable saw blade and related mounting provisions to clarify the function and special relationships of the various components described in the text.

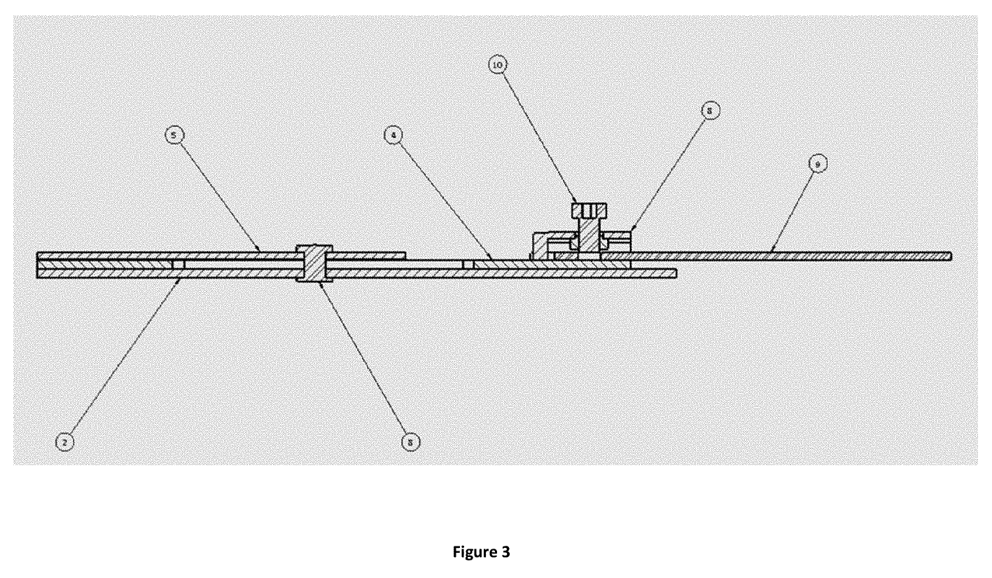

It will be understood that the invention is not limited to the embodiments above-described and various modifications and improvements can be made without departing from the various concepts herein. Except where mutually exclusive, any of the features may be employed separately or in combination with any other feature and the invention extends to and includes all combinations of one or more features described herein to mount a removable sawing blade to any form of a reciprocating hedge trimmer.

1. A hand-held hedge trimmer consisting of a stationary blade and a reciprocating blade powered by an electric motor, whether deriving power via a cord or a battery, whether designed to cut on one side or both sides.

2. A hand-held hedge trimmer as in claim 1 except powered by an internal combustion engine.

3. A hedge trimmer mounted on an extension pole that is rigid or articulating.
